(19) United States
(12) Patent Application Publication
(10) Pub. No.: US 2017/0111731 A1
(43) Pub. Date: Apr. 20, 2017

(54) MICROPHONE ASSEMBLY WITH SUPPRESSED FREQUENCY RESPONSE

(71) Applicant: Sonion Nederland B.V., Hoofddorp (NL)

(72) Inventor: Egon Merks-Swolfs, Hoofddorp (NL)

(21) Appl. No.: 15/280,261

(22) Filed: Sep. 29, 2016

(30) Foreign Application Priority Data
Oct. 20, 2015 (EP) 15190561.9

(51) Int. Cl. H04R 1/28; H04R 19/04

(52) U.S. Cl. CPC H04R 1/2807; H04R 1/2838; H04R 19/04; H04R 2201/003; H04R 25/48

(57) ABSTRACT

The present invention relates to a microphone assembly comprising a microphone unit for converting incoming acoustical sound to an electrical signal, and a rear volume comprising acoustically connected rear volume compartments, said acoustically connected rear volume compartments setting an effective acoustical impedance of said rear volume in order to reduce the sensitivity of the microphone assembly with respect to a resonance peak. The present invention further relates to a hearing device comprising a microphone assembly.

### CONNECTIONCROSS-REFERENCE TO RELATED APPLICATION

This application claims the benefit of European Patent Application Serial No. 15190561.9, filed Oct. 20, 2016, and titled “Microphone Assembly With Suppressed Frequency Response,” which is incorporated herein by reference in its entirety.

### FIELD OF THE INVENTION

The present invention relates to a microphone assembly having a frequency specific suppressed response. In particular, the present invention relates to a microphone assembly having a reduced frequency response with respect to a resonance peak.

### BACKGROUND OF THE INVENTION

Conventional microphones of today, typically being a MEMS microphone or electret condenser microphone (ECM), generally consist of a sound inlet, a front volume, a sensing element (MEMS or cartridge) and rear volume. A pressure difference between the microphone exterior and interior will generate a volume flow from the sound inlet, through the front volume and sensing element to the rear volume. The magnitude of the volume flow depends on 1) the magnitude of the pressure difference and 2) the frequency dependent acoustic impedance of the flow path. The volume flow that passes the sensor diaphragm of the sensing element has direct relation to the sensitivity of the microphone; the larger the flow the more sensitive the microphone and vice versa.

Conventional MENS and ECM microphones are often represented by a simplified equivalent lumped element model (LEM). The LEM divides the total microphone impedance into three subsystems with their specific acoustic impedance, i.e.
1) the total impedance of the sound port and front volume,
2) the impedance of the sensor element (ECM cartridge or MEMS) and
3) the impedance of the microphone rear volume.

A frequency response of a particular, in this case MEMS, microphone is given in FIG. 1. The response is normalized to its 1 kHz value.

The frequency response shows a low-frequency roll-off, a flat middle region around 1 kHz and a sharp resonance peak at 20 kHz. The sharp resonance peak indicates that the system is undamped, which is favorable if the microphone acoustic self-noise needs to be minimal. Unfortunately, a sharp resonance peak also results in a large difference in the peak sensitivity value versus the value at 1 kHz. This large difference in dynamic range generally is problematic for the front-end electronics of the application.

Conventional measures to reduce the delta peak sensitivity are adding acoustic damping, e.g. by means of placing a grid in the sound port, or by applying an electronic low-pass filter in the microphone amplifier. The microphone amplifier may be implemented as an application specific integrated circuit (ASIC). Adding acoustic damping is easy to implement, but it greatly increases the microphone acoustic self-noise. As to the efficiency of acoustic damping one should expect that the self-noise will increase with 0.5 dB in response to a 1 dB peak reduction. Adding an electronic low-pass filter has less effect on the total noise of the microphone, but comes at the expense of added ASIC complexity, increased power consumption and, not in the least extent, to an increase of output distortion.

Conventional prior art solutions are suggested in both U.S. Pat. No. 6,950,529 and US 2015/0043747 A1.

It may be seen as an object of embodiments of the present invention to provide a microphone assembly with reduced frequency response at or near a resonance peak without suffering from the above-mentioned disadvantages.

### SUMMARY OF INVENTION

The above-mentioned object is complied with by providing, in a first aspect, a microphone assembly comprising
a microphone unit for converting incoming acoustical sound to an electrical signal, and
a rear volume comprising acoustically connected rear volume compartments, said acoustically connected rear volume compartments setting an effective acoustical impedance of said rear volume in order to reduce the sensitivity of the microphone assembly with respect to a resonance peak.

Thus, the present invention relates to a microphone assembly where the effective acoustical impedance of the rear volume is adapted to reduce the sensitivity of the microphone assembly.

The reduced sensitivity may be achieved in a frequency range including the resonance peak. The width of the frequency range may typically be chosen from some hundreds Hz to several kHz.

The incoming acoustical sound may only reach rear volume compartments via the microphone unit in that the acoustically connected rear volume compartments form, in combination, a substantially closed rear volume. Thus, the boundaries of the rear volume as a whole may form a substantially closed volume leaving no acoustical access to the microphone unit via the rear volume.

The rear volume may comprise a first and a second rear volume compartment being acoustically connected via an acoustical filter. The acoustical filter may be a band-stop filter or a notch filter. However, other types of filters may also be applicable. In addition, the microphone assembly may further comprise one or more additional rear volume compartments. The one or more additional rear volume compartments may be acoustically connected to the first and/or the second rear volume compartment connected via one or more acoustical filters. In addition, the one or more additional rear volume compartments may be acoustically via one or more acoustical filters. Again, the acoustical filters may be band-stop filters or notch filters.

The rear volume compartments may be separated by a substantially rigid separation member having the acoustical filter arranged therein or attached thereto. A substantially rigid separation member may thus separate all neighbouring rear volume compartments or only a number thereof. The acoustical filter may be implemented in various ways. For example, the acoustical filter may comprise a number of through-going openings in the substantially rigid separation member. The through-going opening may be provided directly in the substantially rigid separation member. Alternatively, the through-going openings in the substantially rigid separation member may be provided as tube-shaped through-going openings. The length of the tube-shaped through-going openings may be longer than an average thickness of the substantially rigid separation member.

Instead of having the acoustical filter integrated with the substantially rigid separation member the acoustical filter may be implemented as a discrete acoustical filter which may be attached to the substantially rigid separation member using appropriate fastening means. Various types of discrete acoustical filters may be implemented. For example, the discrete acoustical filter comprises a porous material. Examples of porous materials are open foams and (woven or nonwoven) polymer fibres, such as expanded polytetrafluoroethylene (ePTFE).

Alternatively, the discrete acoustical filter may comprise a flexible membrane being suspended in the substantially rigid separation member. Also, the discrete acoustical filter may comprise a passive MEMS structure. Such passive MEMS structures may have the resemblance of the perforated backplate of a MEMS microphone, in which the dimensions of the perforations can be accurately controlled by semiconductor processing.

The microphone assembly may comprise one or more additional rear volume compartments in order to increase the order of the acoustical filter.

The microphone unit of the microphone assembly may comprise a MEMS microphone or an electret microphone. However, other types of microphones may be applicable as well. It should be noted that the microphone assembly may comprise a plurality of microphone units. In case of a plurality of microphone units a substantially closed rear volume comprising acoustically connected rear volume compartments may be associated with each microphone unit. The acoustically connected rear volume compartments may set an effective acoustical impedance of each rear volume in order to reduce the sensitivity of the microphone assembly with respect to a resonance peak.

Moreover, the microphone assembly may further comprise an amplifier for amplifying the electrical signal from the microphone unit, and a front volume being acoustically connected to an acoustical sound inlet for receiving incoming acoustical sound.

In a second aspect, the present invention relates to a hearing device comprising a microphone assembly according to the first aspect, said hearing device comprising a hearing aid being selected from the group consisting of: behind-the-ear, in-the-ear, in-the-canal and completely-in-the-canal.

### BRIEF DESCRIPTION OF THE DRAWINGS

The present invention will now be explained in further details with reference to the accompanying figures, wherein

FIG. 1 shows a prior art frequency response,

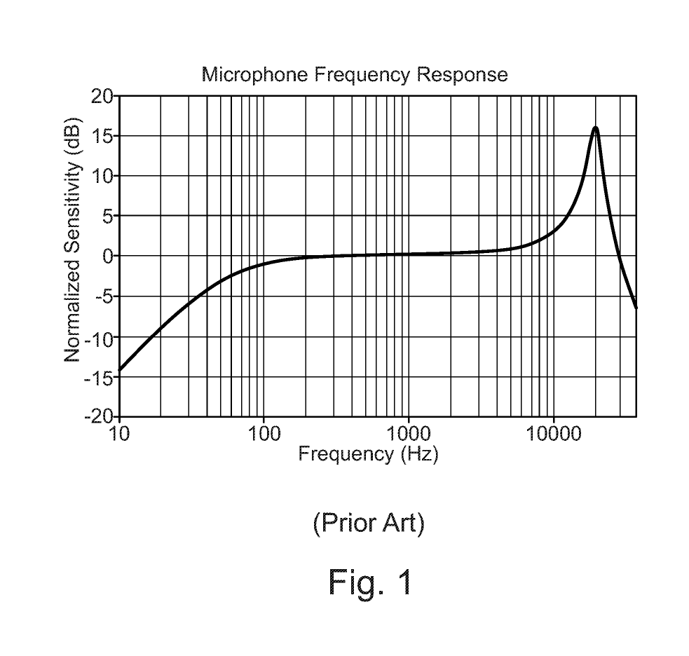

FIG. 2 shows a MEMS microphone assembly having a rear volume with two compartments and an associated lumped element model,

FIG. 3 shows frequency responses with different alpha's,

FIG. 4 shows the open noise levels associated with the frequency responses of FIG. 3 for different alpha's in case of a second order band-stop filter,

FIG. 5 shows measured and simulated response curves in case of a second order band-stop filter,

FIG. 6 shows various rear volume configurations,

FIG. 7 shows frequency and noise response curves for different band-stop filters, and

FIG. 8 shows various filter implementations.

While the invention is susceptible to various modifications and alternative forms, specific embodiments have been shown by way of example in the drawings and will be described in details herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

In its broadest aspect the present invention relates to a microphone assembly with the capability of suppressing the microphone assembly response at or around a resonance peak, while leaving the frequency response at frequencies outside a filter range essentially unaffected. The present invention is also applicable in relation to other applications, including the suppression of a microphone response at certain ultrasonic frequencies, or the suppression of unwanted resonances.

Generally, the suppression of the frequency response at or around the resonance peak is provided by introducing an acoustical filter in a substantially closed rear volume of the microphone assembly. The acoustical filter is specific to a single frequency (notch filter) or to a specific frequency band (band-stop filter). The order of the acoustical filter can be changed to alter frequency specificity. Increasing the order of the acoustical filter sharpens the filter transitions and hence increases the filter specificity.

The acoustical filter is implemented by placing a structure inside the rear volume of microphone assembly such that the effective acoustic impedance of the rear volume is changed to the required filter impedance. The effective acoustical impedance of the microphone assembly changes in a manner so that it acts as a rejection filter to the volume flow that passes through a sensing element (microphone) of the microphone assembly. The volume flow is only allowed to reach the rear volume via the sensing element (microphone). The reduced volume flow effectively reduces the sensitivity of the microphone.

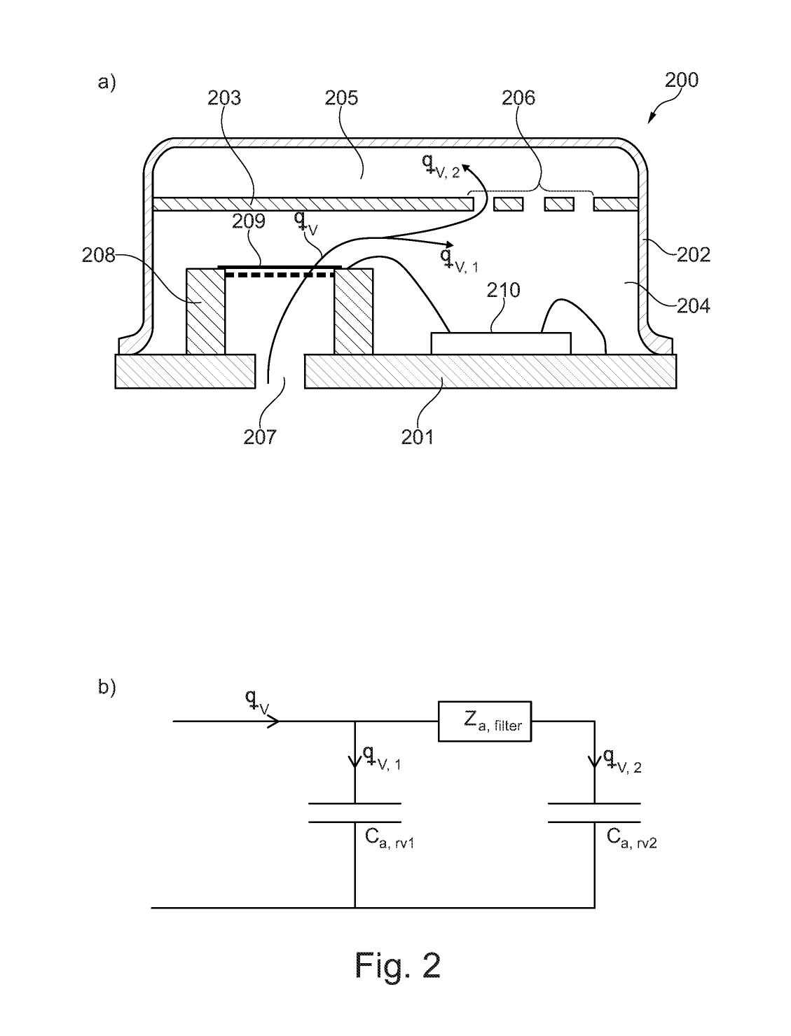

Thus, according to the present invention the impedance of the substantially closed microphone rear volume is changed such that it acts as a rejection filter to the volume flow (qᵥ) that passes through the sensing element 209, cf. FIG. 2. The filter is implemented by dividing the substantially closed microphone rear volume into two or more rear volume compartments, cf. rear volume compartments 204, 205 in FIG. 2a, and placing a filter structure with a specific acoustic impedance (_{za,filter}) between the compartments. The main function of the structure is to add an acoustic mass and (optionally) an acoustic resistance (damping) in between the compartments, such that the ensemble of the filter structure and the acoustic compliances of the rear volumes function as a rejection filter to qᵥ.

FIG. 2a illustrates the above-mentioned principle for a MEMS microphone 200. In FIG. 2a the filter 206 is implemented by a perforated plate, which divides the rear volume with compliance C_{a,rv}, into two rear volume compartments with cavities 204, 205 with compliances C_{a,rv1} and C_{a,rv2}. The filter structure 206 is created by a number of perforated holes, which create a flow path with between the two compliances. The MEMS microphone further comprises a substrate 201 having a sound inlet 207, a housing 202, a MEMS sensing element 208, 209 and an ASIC 210. As addressed above incoming sound is only allowed to reach the two rear volume compartments 204, 205 via the MEMS sensing element 208, 209.

FIG. 2b shows a lumped element model of the modified rear volume only, assuming no change in the rest of the microphone system. The model also shows that the initial volume flow (qᵥ) is divided into two flows; one (q_{v,1}) that flows directly to the first compartment 204 with compliance C_{a,rv1} and one (q_{v,2}) that flows through the filter structure to the second compartment 205 with compliance C_{a,rv2}.

The following relationships apply between the compliances of the total rear volume, Ca,rv, the first compartment 204, C_{a,rv1}, and the second compartment 205, C_{a,rv2}:

C_{a,rv1}=α×C_{a,rv}

C_{a,rv2}=(1−α)×C_{a,rv}

C_{a,rv1}+C_{a,rv2}=C_{a,rv}

0≦α≦1

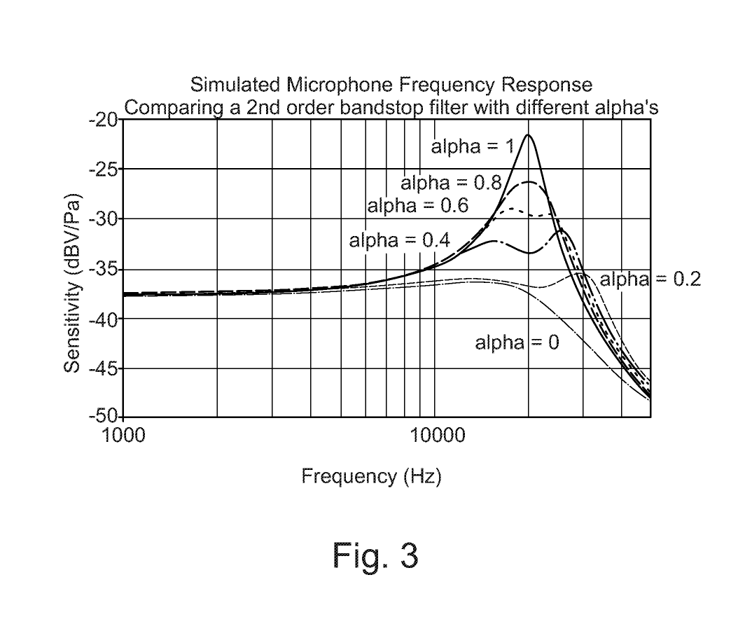

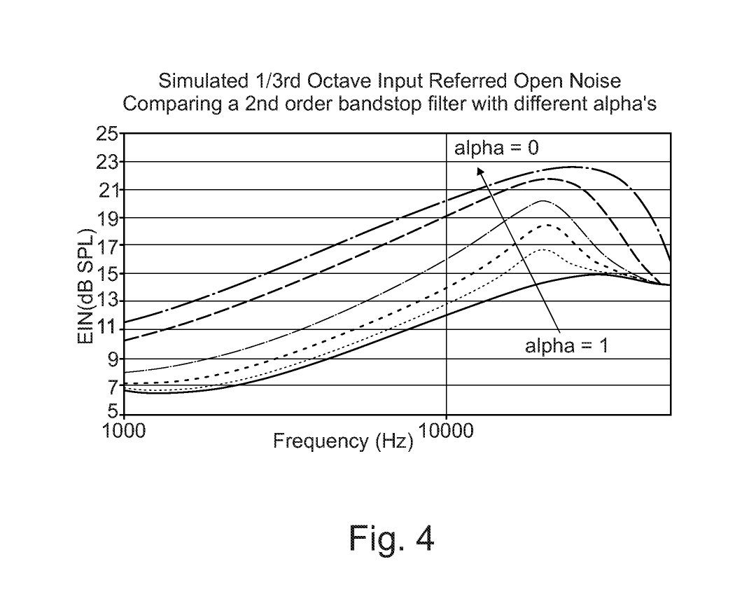

An important design parameter for the acoustical filter is the ratio, a, between the volume of the first compartment 204 and the volume of the initial rear volume. This ratio can be between 0, i.e. the second compartment 205 (in this case only the second) have a sum of volumes equal to the initial rear volume and 1, i.e. the first compartment 204 has the same volume as the initial rear volume. In general, a smaller alpha allows for a larger flow qᵥ₂, which results in a stronger filter with higher rejection factor. However, as a smaller alpha also increases the (unwanted) self-noise of the microphone, there exist a (application specific) trade-off between filter efficiency and added noise. The effect of different alpha's on the peak damping and noise performance in case of a second order band-stop are shown in FIGS. 3 and 4.

The acoustic mass of the filter structure Z_{a,filter} is chosen such that the filter resonance is at the required frequency. To do this the following relationship is used:

$${f}_{0} = \frac{1}{2 π \sqrt{{M}_{a , filter} {C}_{a , rv} ( 1 - α ) α}}$$

As such, the acoustic mass M_{a,filter} depends on the chosen value for alpha, the given compliance of the original microphone rear volume C_{a,rv} and the selected frequency f₀. When alpha and the acoustic mass are set, the sharpness and rejection factor of the filter (Q) is further controlled by selecting the appropriate value of the acoustic resistance R_{a,filter} according to:

$$Q = \frac{1}{{R}_{a , filter} \sqrt{α ( 1 - α )}} \cdot \sqrt{\frac{{M}_{a , filter}}{{C}_{a , rv}}}$$

When R_{a,filter} is chosen 0, the Qₙ goes to infinity, and the filter will act as a notch filter that only works at f₀. Any other value for R_{a,filter} will dampen the notch and will lower the sharpness Qₙ of the filter. Consequently, the filter then acts as a band-stop filter to a frequency range centered at f₀.

In general, microphones for hearing aids applications can have a peak resonance between 5 kHz and 40 kHz, where electrets microphones generally have their resonance below 10 kHz and MEMS microphones generally have a peak between 10 kHz and 40 kHz. This difference between ECM and MEMS is mostly explained by the difference in acoustic compliance of the sensor diaphragm and the overall acoustic mass, i.e. the diaphragm acoustic compliance of current MEMS designs is 3 to 5 times lower than the diaphragm compliance of ECMs.

Because the rear volume compliances of existing ECM and MEMS microphones are more or less in the same order of magnitude, the value for the filter acoustic mass will typically be smaller for MEMS microphones than for ECMs. For example, when setting alpha at 0.8, a MEMS microphone with f₀ at 20 kHz and rear volume of 6 mm³ needs M_{a,filter} to be about 9.5×10³ kg/m⁴. For a specific ECM with f₀ at 6 kHz and also 6 mm³ rear volume, M_{a,filter} now needs to be 104.7×10³ kg/m⁴. This is an order of magnitude larger than for the MEMS.

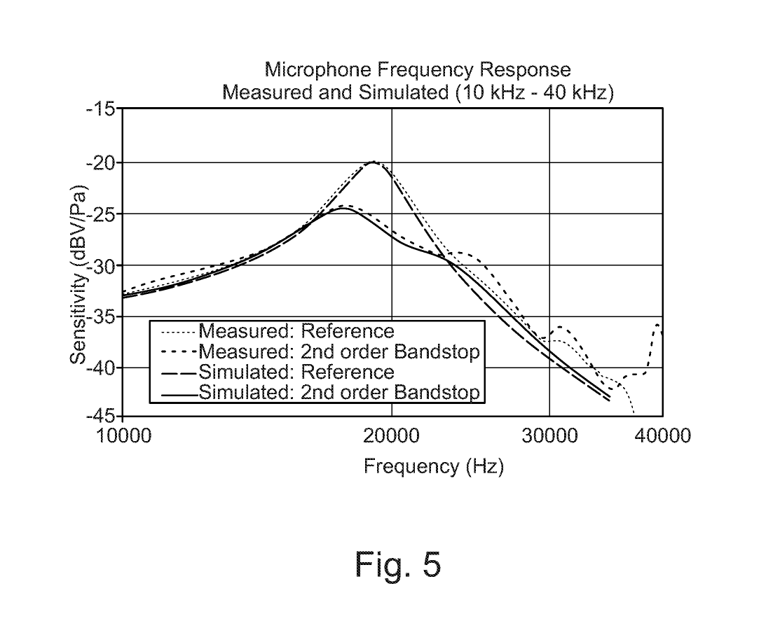

FIG. 5 shows the measured and simulated results of actual built demonstrators. It concerns two MEMS microphones with identical buildup. However, one of the MEMS microphones does not have a filter structure (reference microphone), while the other MEMS microphone has a perforated plate with thickness of 80 um dividing the rear volume into a first compartment of 4 mm³ and a second compartment of 1 mm³. As such, the design parameter alpha was set at 0.8. The filter structure has 5 holes of radius 45 um. From these dimensions and using known theory, the acoustic mass and resistance of the filter holes were calculated as 1.2×10⁴ kg/m⁴ and 5.4×10⁸ Pa·s/m⁴, respectively. Simulations were found to match the measurements results when the values for the acoustic mass and resistance were set to 1.3×10⁴ kg/m⁴ and 5.6×10⁸ Pa·s/m⁴, respectively. This result indicates a good theoretical understanding of the principle underlying the present invention and demonstrates the practical feasibility of the present invention.

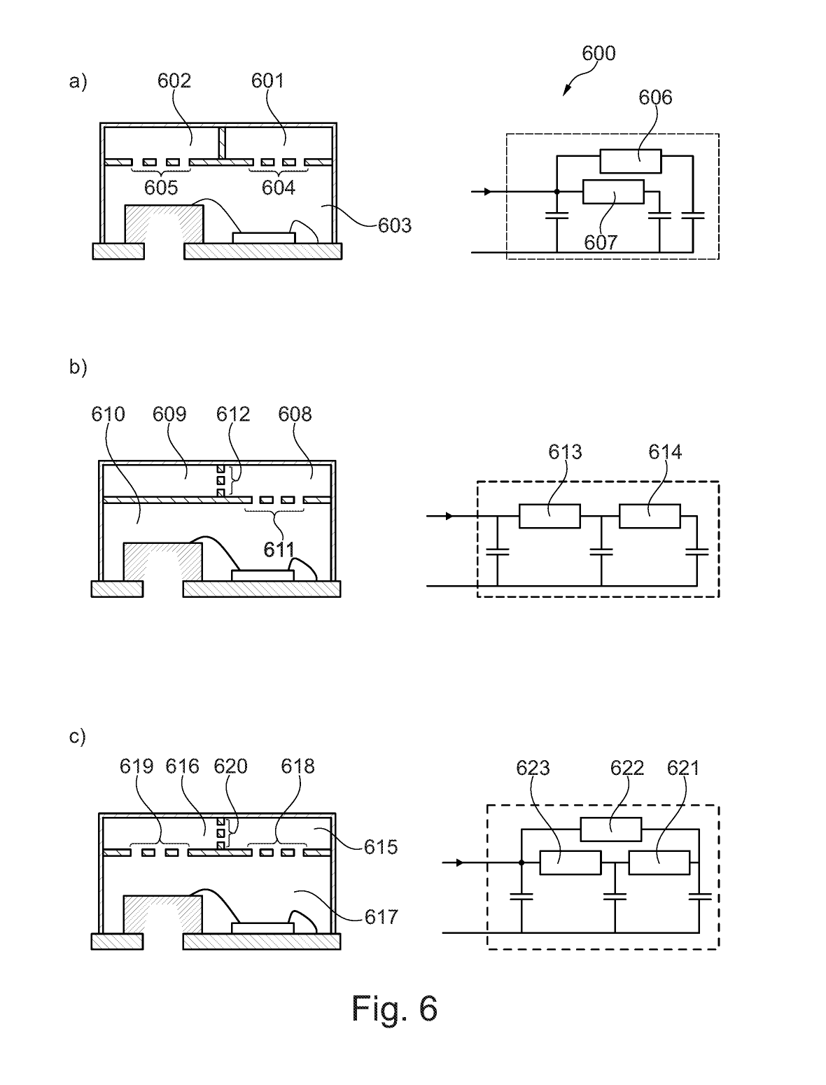

As indicated in FIG. 6 the rear volume compartments may be arranged in different ways. In FIG. 6a the filters 604, 605 are coupled in parallel when separating rear volume compartments 601, 602 and 603. The parallel coupled filters 604, 605 are denoted 607, 606, respectively, in the associated lumped element model. The capacitors indicate the respective compliances of the rear volume compartments 601, 602 and 603. In FIG. 6b the filters 611, 612 are coupled in series when separating rear volume compartments 608, 609 and 610. The series coupled filters 611, 612 are denoted 613, 614, respectively, in the associated lumped element model. Again, the capacitors indicate the respective compliances of the rear volume compartments 608, 609 and 610. In FIG. 6c the filters 618, 619, 620 are coupled in both series and parallel when separating rear volume compartments 615, 616 and 617. The series and parallel coupled filters 618, 619, 620 are denoted 622, 623, 621, respectively, in the associated lumped element model, and the capacitors indicate the respective compliances of the rear volume compartments 615, 616 and 617. It should be noted that the three rear volume compartments may be arranged differently compared to the illustrations given in FIG. 6. For example, the two small rear volume compartments do not need to be adjacent to each other. In FIGS. 6a-c only a single microphone unit is depicted. It should be noted however that a plurality of microphone units could be applied. In case of a plurality of microphone units a rear volume comprising acoustically connected rear volume compartments is associated with each microphone unit. It should be noted that the rear volumes of FIGS. 6a, 6b and 6c are substantially closed rear volumes although they are all divided into rear volume compartments.

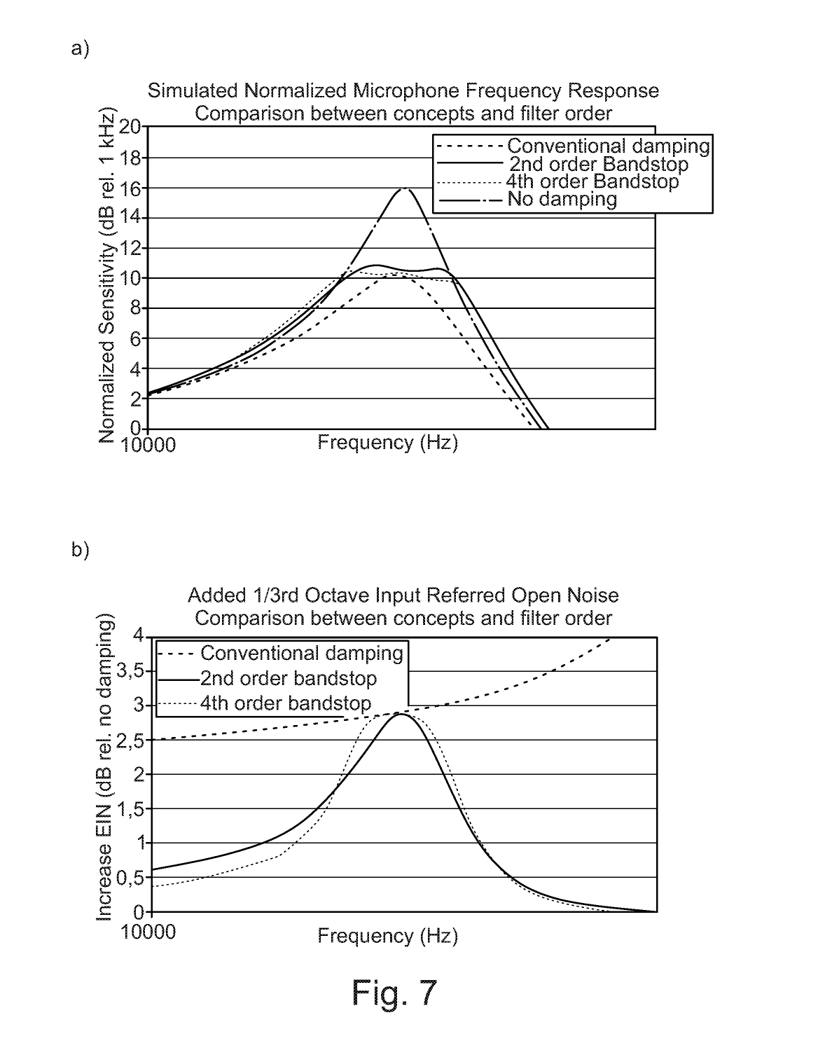

FIG. 7 shows simulation results of the effect of using a higher order filter on the frequency response and noise performance in case of parallel coupled rear volume compartments. Clearly, using the 4th order filter (dashed lines) gives a flatter frequency response (FIG. 7a) and less added noise (FIG. 7b), compared to conventional damping (dotted lines) and a 2^{nd} order filter (solid lines).

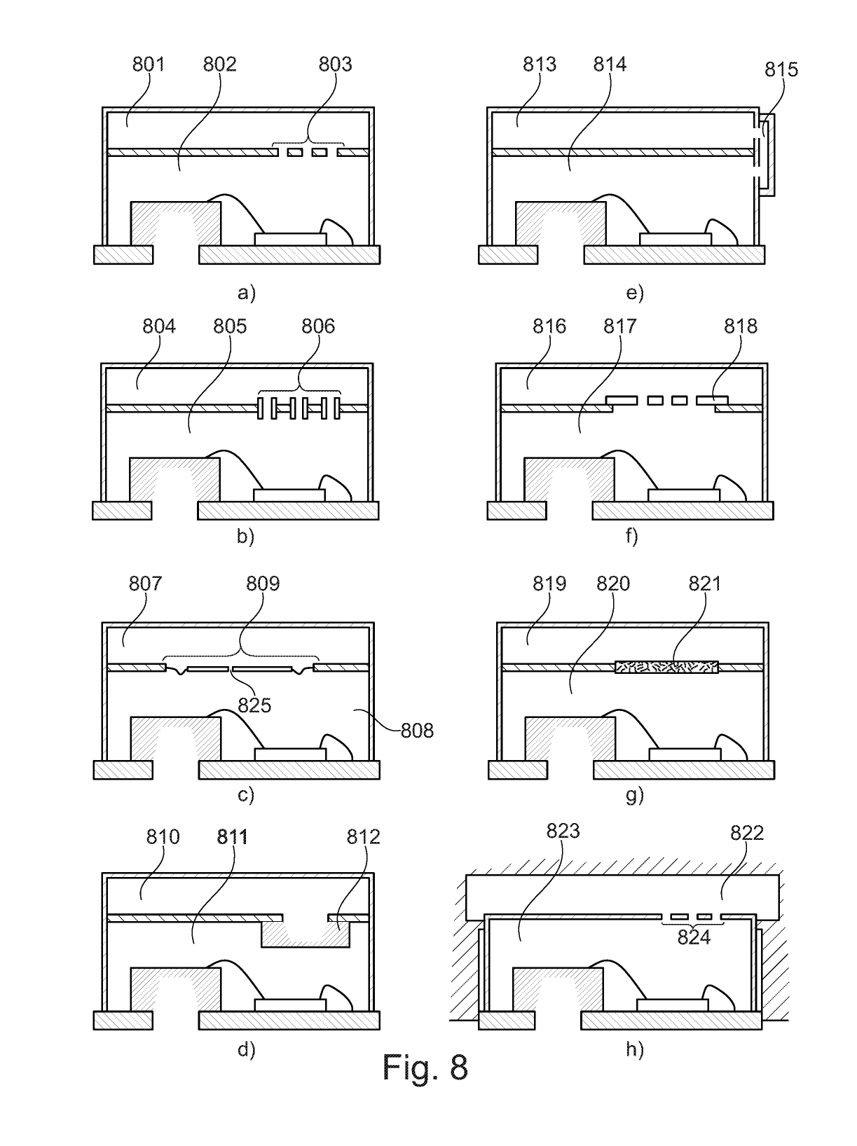

FIG. 8 shows ways of implementing the acoustical filter within a microphone assembly. In FIG. 8 a MEMS package has been used for illustration purposes. However, the principles are applicable to ECM packages as well.

In FIG. 8a the acoustical filter 803 is formed by a perforated plate. Thus, the filter impedance is implemented by introducing a plate of a certain thickness that splits the rear volume into two compartments 801, 802. The two compartments 801, 802 have a total combined volume preferably being equal to the initial rear volume. The inserted plate has a number of through-going openings. The openings may be perforated, lasered, cut, molded, pressed or otherwise machined. The shape, size and number of the openings are chosen such that, in combination with the plate thickness and the acoustic impedances of the compartments, the ensemble of acoustic impedances of the openings creates the required acoustic impedance of the filter. The applied plate should be rigid and it may be of any suitable material.

In FIG. 8b tube-shaped openings are applied. The filter impedance is thus implemented by having two compartments 804, 805 that are acoustically connected via one or more tubes 806. As seen in FIG. 8b the tubes define conduits, having a certain wall thickness, that protrude into the compartments beyond the thickness of the separation structure. The number, length, cross-sectional area and cross-sectional shape of the tubes are chosen such that, in combination with the acoustic impedances of the cavities, the ensemble of acoustic impedances of the tubes creates the required acoustic impedance of the filter. The tube wall should be rigid and can be of any material.

In FIG. 8c the filter is implemented as one or more flexible membranes 809. Again, tilter impedance is implemented by having two compartments 807, 808 that are acoustically connected via one or more flexible membranes. The size, thickness and material of the membrane(s) are chosen such that, in combination with the acoustic impedances of the cavities, the acoustic impedance of the membrane creates the required acoustic impedance of the filter. The membrane(s) implementation should include a vent opening 825 that allows for barometric pressure relief between the sub-compartments and the pressure outside the microphone. The vent opening should not change the filter function.

In FIG. 8d a semiconductor process-based device 812 is applied. The impedance that connects the sub-compartments 810, 811 can be realized by means of a semiconductor device, such as a MEMS. The semiconductor device 812 can be a passive device with a fixed and technology inherent highly accurate impedance.

In FIG. 8e a path 815 of a through-housing connection is applied. The filter impedance is implemented by having two rear volume compartments 813, 814 that are acoustically connected via path or paths 815 on the exterior of the microphone system. The acoustic path or paths 815 are connected to the sub-compartments 813, 814 via a through-housing connection, which can again be a perforation or a tube. The number, length, cross-sectional area and cross-sectional shape of the path or paths 815 and through-housing connections are chosen such that, in combination with the acoustic impedances of the cavities, the ensemble of acoustic impedances creates the required acoustic impedance of the filter.

In FIG. 8f a filter structure 818 on a support is provided. The filter impedance is implemented by either concepts a), b) or c), but the filter structure is realized in a separate assembly. The separate assembly is then placed on a support inside the rear volume of the microphone whereby compartments 816, 817 are provided. This closely relates to concept d), but the assembly build extends also to non-semiconductor based processes.

In FIG. 8g a porous material 821 is applied between the two compartments 819, 820. This concept is similar to concept f) with the difference that the filter structure now consists of a porous material that has a certain acoustic impedance.

In FIG. 8h an application aided configuration is provided. The filter impedance is implemented by either concepts a) to g), but now at least one of the sub-compartments 822, 823 is created inside the system of the application but external to the microphone assembly itself.

In FIGS. 8a-h only a single microphone unit is depicted. It should be noted however that a plurality of microphone units could be applied. In case of a plurality of microphone units a substantially closed rear volume comprising acoustically connected rear volume compartments is associated with each microphone unit.

It should be noted that the rear volumes of FIGS. 8a-8g are all substantially closed rear volumes although they are divided into various arrangements of rear volume compartments. In FIG. 8h the rear volume compartment 822 is provided external to the microphone assembly itself. However, despite this design variant incoming sound is only allowed to reach the rear volume compartments 822, 823 via the MEMS sensing element. The rear volume compartments 822, 823 thus constitute, in combination, a substantially closed rear volume.

As a general consideration the location of the filter structure on the structure that separates the rear volume compartments is arbitrary. The locations of filter sub-structures on the structure that separates the rear volume compartments is also arbitrary. The total size of the filter structure depends on the required filter function and is in the limit constrained by the system dimensions. Implementation principles can be combined to achieve the required filter impedance.

1. A microphone assembly comprising
a microphone unit for converting incoming acoustical sound to an electrical signal, and
a rear volume comprising acoustically connected rear volume compartments, said acoustically connected rear volume compartments setting an effective acoustical impedance of said rear volume in order to reduce the sensitivity of the microphone assembly with respect to a resonance peak.

2. A microphone assembly according to claim 1, wherein the acoustically connected rear volume compartments form, in combination, a substantially closed rear volume.

3. A microphone assembly according to claim 1, wherein the effective acoustical impedance of the rear volume is adapted to reduce the sensitivity of the microphone assembly in a frequency range including the resonance peak.

4. A microphone assembly according to claim 3, wherein the rear volume comprises a first and a second rear volume compartment being acoustically connected via an acoustical filter.

5. A microphone assembly according to claim 4, wherein the acoustical filter comprises a band-stop filter.

6. A microphone assembly according to claim 4, wherein the acoustical filter comprises a notch filter.

7. A microphone assembly according to claim 4, further comprising one or more additional rear volume compartments, said one or more additional rear volume compartments being acoustically connected to the first and/or the second rear volume compartment via one or more acoustical filters.

8. A microphone assembly according to claim 7, wherein the acoustical filter comprises a band-stop filter.

9. A microphone assembly according to claim 7, wherein the acoustical filter comprises a notch filter.

10. A microphone assembly according to claim 4, wherein a number of the rear volume compartments are separated by a substantially rigid separation member having the acoustical filter arranged therein or attached thereto.

11. A microphone assembly according to claim 10, wherein the acoustical filter comprises a number of through-going openings, such as tube-shaped through-going openings, in the substantially rigid separation member.

12. A microphone assembly according to claim 10, wherein the acoustical filter comprises a discrete acoustical filter attached to the substantially rigid separation member.

13. A microphone assembly according to claim 10, wherein the discrete acoustical filter comprises a porous material.

14. A microphone assembly according to claim 10, wherein the discrete acoustical filter comprises a flexible membrane.

15. A microphone assembly according to claim 10, wherein the discrete acoustical filter comprises a passive MEMS structure.

16. A microphone assembly according to claim 1, wherein the microphone unit comprises a MEMS microphone.

17. A microphone assembly according to claim 1, wherein the microphone unit comprises an electret microphone.

18. A microphone assembly according to claim 1, further comprising an amplifier for amplifying the electrical signal from the microphone unit, and a front volume being acoustically connected to an acoustical sound inlet for receiving incoming acoustical sound.

19. A microphone assembly according to claim 1, wherein the microphone assembly comprises a plurality of microphone units, and wherein a substantially closed rear volume comprising acoustically connected rear volume compartments is associated with each microphone unit.

20. A hearing device comprising a microphone assembly according to claim 1, said hearing device comprising a hearing aid being selected from the group consisting of: behind-the-ear, in-the-ear, in-the-canal and completely-in-the-canal.
